(19) United States
(12) Patent Application Publication
(10) Pub. No.: US 2017/0266886 A1
(43) Pub. Date: Sep. 21, 2017

(54) CAMERA-BASED DETERMINING OF ROUGHNESS FOR ADDITIVELY MANUFACTURED COMPONENTS

(71) Applicant: MTU Aero Engines AG, Munich (DE)

(72) Inventors: Thomas HESS, München (DE); Georg SCHLICK, Munich (DE); Alexander LADEWIG, Bad Wiessee (DE)

(73) Assignee: MTU Aero Engines AG, Munich (DE)

(21) Appl. No.: 15/503,517

(22) PCT Filed: May 20, 2015
(86) PCT No.: PCT/DE2015/000261

§ 371 Date: May 31, 2017

(30) Foreign Application Priority Data
Jul. 30, 2014 (DE) 10 2014 214 939.8

(51) Int. Cl. B29C 67/00; B33Y 50/02; B33Y 10/00

(52) U.S. Cl. CPC B29C 67/0088; B29C 67/0077; B33Y 10/00; B33Y 50/02

(57) ABSTRACT

The invention relates to a method and a device for the additive manufacturing of components by the layer-by-layer joining of powder particles to one another and/or to an already created pre-product or substrate, via the selective interaction of the powder particles with a high-energy beam (13) to create a layer, wherein a formed layer (14) is captured using a camera (6), wherein a contour of the deposited layer (14) is determined from an image of the deposited layer captured by the camera (6), and wherein the roughness of the surfaces of the formed component is determined from the contour.

### BACKGROUND OF THE INVENTION

Field of the Invention

The present invention relates to a method and a device for the additive manufacture of components by layer-by-layer joining of powder particles to one another and/or to an already produced pre-product or substrate via selective interaction of the powder particles with a high-energy beam, in particular a method for selective laser-beam or electron-beam melting.

Prior Art

Additive manufacturing methods for the manufacture of a component, such as, for example, selective laser melting, selective electron-beam melting, or laser deposition welding, in which the component is built up layer-by-layer with the application of powder material, are employed in industry for so-called rapid tooling, rapid prototyping, or also for the production of mass-produced products within the scope of rapid manufacturing. In particular, such methods can also be used for the manufacture of turbine parts, particularly parts for aircraft engines, in which, for example, these additive manufacturing methods are advantageous based on of the material used. An example of this is found in DE 10 2010 050 531 A1.

In the additive manufacture of components using a layer-by layer introduction of material, it is known to monitor the deposition process in order to be able to detect deviations from the target state, thus for example, deviations from the desired shape, and to be able to take corrective measures, such as a change in the process parameters. Thus, it is proposed in WO 2012/100 766 A1 to establish an optical and thermal monitoring of the deposited layers in order to make possible a direct and continuous monitoring of the additive manufacture. In this known monitoring method, the deposited layer is captured in a view from the top, and the properties on the top side are determined and evaluated for the monitoring. Of course, the monitoring proposed therein does not make possible the complete abandoning of testing a component after the component is manufactured. Usually, correspondingly produced components, in which the surface quality is of importance, have still not been subjected to a roughness measurement in order to determine the surface roughness. The roughness is usually tested by a tactile measurement, which is time-consuming and is difficult or even impossible to carry out for specific surfaces of the component.

### DISCLOSURE OF THE INVENTION

### Object of the Invention

It is thus the object of the present invention to provide a method for the additive manufacture of components by layer-by-layer joining of powder particles to one another and/or to an already produced pre-product or substrate, via selective interaction of powder particles with a high-energy beam, a method in which the above-mentioned problem of additional component testing in order to determine the surface quality can be avoided. Nevertheless, the method shall be simple and able to be reliably conducted in order to be able to use the corresponding additive manufacture in industrial processes.

### Technical Solution

This object is achieved by a method having the features of claim 1. Advantageous embodiments are the subject of the dependent claims.

The invention proposes to detect the roughness of surfaces of the component to be fabricated by means of the detection of the contour of individual deposited layers, so that a downstream measurement of roughness on the surfaces of the component can be avoided. In addition, this method has the advantage that the further deposition process can be adapted directly to the detected values in order to avoid re-working or inadmissible roughness values. In addition, with the method according to the invention, roughness values of surfaces that are no longer accessible or only difficult to access after the complete fabrication of the component, such as surfaces of cavities, can be detected or captured. For this purpose, a deposited layer, which is also called a produced layer, is determined; it is detected or captured by a high-resolution camera and the contour of the deposited layer is determined. The roughness of the surface of the produced component that runs crosswise to the layer plane of the deposited layer can be determined from the contour of the deposited layer.

Contour is to be understood as the boundary surface of the produced layer opposite the unsolidified powder of the layer coating. Therefore, the contour represents a surface, which can be considered, however, as a contour line based on the delimited thickness of the deposited layer in the top view. The width of the contour or the contour line in this case results from the distance between the boundary line of the produced layer at the top of the layer and at the bottom of the layer in the top view.

The method can be used, in particular, in selective laser-beam melting or in selective electron-beam melting, so that laser beams or electron beams can be used as high-energy beams.

The resolution of the high-resolution camera with which images of the deposited layers can be taken in order to evaluate or analyze the images with respect to the contour of the produced layer, particularly in an automated analysis unit, can have a resolution in the range of the diameter or of the maximum dimension of the impact region of the high-energy beam onto the powder, or a fraction thereof, such as, for example, one-half or one-third of the diameter or of the maximum dimension of the impact region.

The roughness of a surface of the additively produced component can be determined from a comparison of the target course and the actual course of the contour or the contour line and/or from the cast shadow of the contour and/or the width of the contour and/or the sharpness of the contour.

The comparison of the target course and the actual course of the contour makes possible a direct determination of deviations crosswise to the surface, and thus the roughness of the surface.

Differences in the thickness of the layer, thus differences with respect to the extent of the layer in the direction crosswise to the layer plane in the region of the contour, can be determined from the cast shadow of the contour; these differences also permit conclusions on the roughness of the produced surfaces. Of course, a height profile of the produced layer in the region of the contour, which can be obtained in another way from the image information, can also be drawn on for determining the roughness. In addition, the cast shadow gives indications as to the orientation of the contour, thus the boundary surface of the layer running crosswise to the layer plane, which also causes the roughness of the surface. The determination of the width of the contour line, which represents the distance between the upper boundary line at the top of the layer and the lower boundary line at the bottom of the layer in the top view, can also serve for this purpose.

The sharpness of the contour line that represents a measure for the exact determination of boundary lines or the possible error in the determination of the position of boundary lines of the produced layer can also enable conclusions on the roughness of the surface.

For determination of the roughness, the captured values can also be subjected to another workup. For example, an averaged contour line that is taken as the basis for the roughness determination can be determined from the measured values of the course of the contour line.

The analysis of the images of the deposited layers can be automated in an analysis unit, which can be provided, for example, by a data processing unit which is suitably programmed.

A plurality of images with the high-resolution camera can be taken, in particular from different perspectives and/or with different illumination, for capturing the contour of the deposited layer.

The values determined by capturing the contour or the roughness values determined therefrom can be stored for documentation of the surface quality of the produced component as well as also used for influencing the parameters for the deposition process of subsequent layers and/or other components, in order to optimize the surface quality of the produced components. Correspondingly, an analysis unit can provide the analysis result automatically to a control and/or regulating system, so that the control and/or regulating system can control or regulate the device according to the analysis result.

### BRIEF DESCRIPTION OF THE FIGURES

The appended drawings show in a purely schematic way in:

FIG. 1—a schematic representation of a device for the additive manufacture of components on the example of selective laser melting with a camera for the roughness determination;

FIG. 2—a representation of a top view onto the powder bed or the component image, respectively, of a device from FIG. 1 with a produced layer, and in

FIG. 3—a partial sectional view through a produced layer in the region of the contour.

### EXAMPLES OF EMBODIMENT

Further advantages, characteristics and features of the present invention will be made clear in the following detailed description of examples of embodiment, the invention not being limited to these embodiment examples.

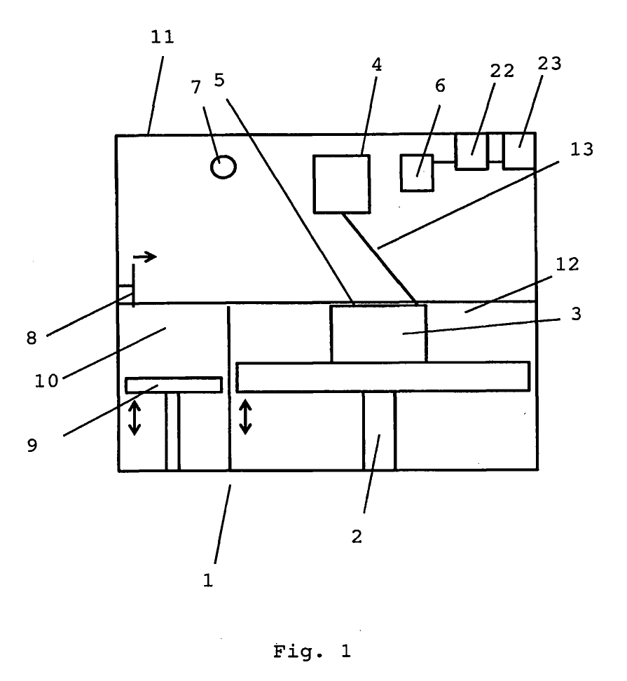

In a purely schematic representation, FIG. 1 shows a device 1, as can find use, for example, in selective laser melting for the additive manufacture of a component. The device 1 comprises a lift table 2, on the platform of which is disposed a semi-finished product or pre-product 3, onto which material is deposited layer by layer in order to produce a three-dimensional component. For this purpose, powder that is found in a powder supply container 10 above a lift table 9 is moved by means of a slider 8, layer by layer, over the pre-product 3 and is subsequently joined to the already present pre-product 3 by melting by means of the laser beam 13 of a laser 4. After the complete introduction of a layer 5, the lift table 2 is lowered corresponding to the movement possibility indicated by the double arrow, in order to be able to introduce a new powder layer with the slider 8.

The powder material is joined to the pre-product 3 in the powder layer 5 via the laser 4, depending on the desired shape of the component to be fabricated, so that any three-dimensional shape can be produced. Correspondingly, the laser beam 13 is guided over the powder bed 12, in order to melt powder material via different impact points on the powder bed which corresponds to the desired shape of the three-dimensional component in the sectional plane of the component to be produced, which corresponds to the powder layer plane, and to join to the already produced part of a component or to an initially provided substrate. In this way, the laser beam 13 can be guided over the surface of the powder bed 12 by a suitable deflection unit and/or the powder bed could be moved opposite the laser beam 13.

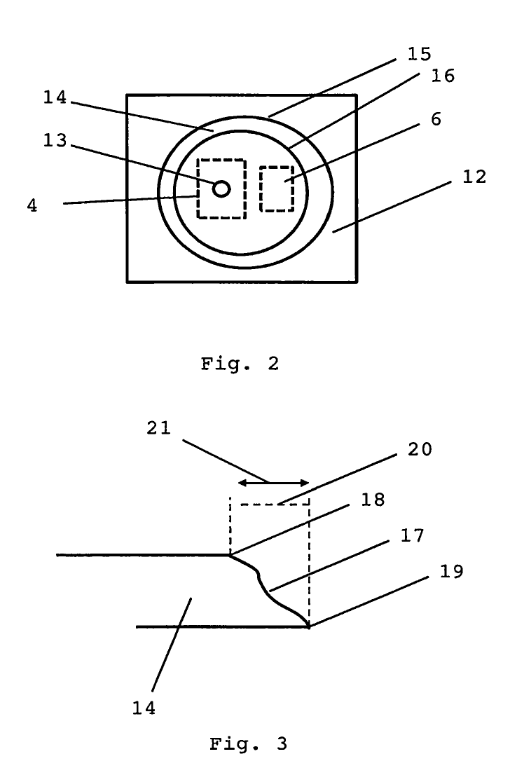

A top view onto the powder bed 2 or the processing region of the device of FIG. 1 is shown in FIG. 2, in which a produced layer 14 is shown. In the exemplary embodiment shown, the produced layer 14 is a ring with an outer contour 15 and an inner contour 16. This means that the component to be fabricated has a cavity delimited by the inner contour 16 after it is completely fabricated.

Since the produced layer 14 forms a sectional plane in the component to be fabricated, the outer contour 15 and the inner contour 16, with the boundary surfaces running crosswise to the layer plane and corresponding to the thickness of the produced layer 14, represent surfaces of the fabricated component, so that the roughness of the surfaces is determined by the course of the corresponding contour, i.e., the outer contour 15 or the inner contour 16.

The contour 17 of the produced layer 14 thus represents, as is shown in FIG. 3, a shape that defines the region of the produced layer 14, and in fact, both laterally in a direction parallel to the layer plane as well as also between the top and the bottom of the produced layer. Correspondingly, a contour line 20 can be defined, which represents the boundary line of the produced layer in a top view. The width 21 of the contour line results from the distance between the boundary lines 18, 19 of the produced layer at the top and at the bottom of the produced layer in the top view.

Based on the given thickness of a produced layer 14, in this case, the roughness of the surfaces is determined not only by the course of the contour or the deviation in the contour from a target contour in a direction parallel to the layer plane, but also by the orientation or alignment of the boundary surface formed at the contour line in the thickness direction and/or the course of the layer thickness at the contour line. For example, an orientation of the boundary surface in the thickness direction, which deviates from a perpendicular orientation of the boundary surface relative to the layer plane, can lead to deviations from the targeted shape of the component and thus to roughness of the component surface, when the component surfaces are to run in this region perpendicular to the layer plane in the produced component. Irregularities in the thickness of the produced layer at the contour line can also be causes for roughness of the produced component surfaces due to effects on the deposition of the next layer, so that knowledge of the layer thickness at the contour line gives an indication of the roughness of the component surface produced there.

Correspondingly, in the device shown in FIG. 1, a camera 6 is provided that makes possible a capturing of the produced layer 14 and thus the contour of the individual layers of a component. An automatic capture and analysis of the contour of a produced layer 14 can be conducted by an analysis unit 22, e.g., in the form of a data processing unit that is equipped with suitable software. In the capture and analysis of the captured contour, the following can be drawn on: the lateral deviation of the actual contour in a direction parallel to the layer plane, the thickness of the produced layer 14 at the contour line, the width of the contour line, the sharpness of the contour line, the cast shadow at the contour line, etc.

The analysis unit 22 is connected to the control and/or regulating system 23 in order to be able to provide the analysis result to the control and/or regulating system 23, so that the device for additive manufacture of a component can be controlled and/or regulated as a function of the captured contour and/or roughness.

In order to be able to take a plurality of images of the produced layer 14 from different perspectives, the camera 6 can be movable or a plurality of cameras (not shown) can be provided. In addition, a lighting device 7 can be provided for illuminating the produced layer 14 when taking images with camera 6, which can also be designed as movable in order to make possible different illumination settings. Moreover, a plurality of lighting devices can also be provided.

Although the present invention has been described in detail on the basis of embodiment examples, it is understood by the person skilled in the art that the invention is not limited to these embodiment examples, but rather that modifications are possible in such a way that individual features are omitted or other types of combinations of features can be realized, as long as they are not outside the scope of protection of the appended claims.

The present disclosure includes all combinations of the proposed individual features.

### LIST OF REFERENCE NUMBERS

1 Device for selective laser melting
2 Lift table
3 Semi-finished product or pre-product
4 Laser
5 Layer
6 Camera
7 Lighting
8 Slider
9 Lift table
10 Powder supply container
11 Housing
12 Powder bed
13 Laser beam
14 Produced layer
15 Outer contour
16 Inner contour
17 Contour
18 Boundary line at the top of the layer
19 Boundary line at the bottom of the layer
20 Contour line in the top view
21 Width of the contour line

1. A method for the additive manufacture of components by layer-by-layer joining of powder particles to one another and/or to an already produced pre-product or substrate, via selective interaction of the powder particles with a high-energy beam (13), for the formation of a layer, wherein a formed layer (14) is captured with a camera (6),
wherein
a contour surface of the deposited layer (14) is determined from an image of the deposited layer captured with the camera (6), and in that the roughness of a surface of the formed component is determined from the contour surface.

2. The method according to claim 1, wherein
a high-resolution camera (6) is used, the resolution of which makes possible the resolution of an individual region of impact of the high-energy beam (13) or one-half or one-third of the diameter or a maximum dimension of an impact region of the high-energy beam.

3. The method according to claim 1, wherein
the high-energy beam (13) is a laser beam or an electron beam.

4. The method according to claim 1, wherein
the roughness of at least one surface of the component is determined from the comparison of the target course and the actual course of the contour surface and/or from the cast shadow of the contour surface and/or the width of the contour surface and/or the sharpness of the contour surface.

5. The method according to claim 1, wherein
a height profile is determined at the contour surface and is used for determining the roughness of a surface of the component.

6. The method according to claim 1, wherein
an averaged contour line is determined from the contour surface and this is used for determining the roughness.

7. The method according to claim 1, wherein
a plurality of images of an individual deposited layer (14) is captured by the camera from different perspectives and/or with different illumination.

8. The method according to claim 1, wherein
the determined roughness is used for regulating the parameters for the deposition of subsequent layers and/or for subsequent improving or for re-working the monitored layer.

9. The method according to claim 1, wherein
the determined roughness is documented for characterizing the component.

10. The method according to claim 1, wherein a device is provided for the additive manufacture of components, by layer-by-layer joining of powder particles to one another and/or to an already produced pre-product or substrate, via selective interaction of the powder particles with a high-energy beam (13), for the formation of a layer, wherein the device comprises a platform (2) for supporting the component being produced, a unit for the layer-by-layer disposition of powder, a unit for generating a high-energy beam (4), and at least one camera (6) for imaging a deposited layer,
wherein
in addition, the device comprises an analysis unit that can receive an image captured by the camera (6) and determines a contour of the deposited layer (14) from the image of the deposited layer captured by the camera (6), and/or determines the roughness of a surface of the formed component from the contour surface.

11. The method according to claim 10,
wherein the device includes
at least one camera or a plurality of cameras is or are arranged so that a deposited layer (14) can be captured under different viewing angles.

12. The method according to claim 10,
wherein
the camera is a high-resolution camera (6), the resolution of which makes possible the resolution of an individual region of impact of the high-energy beam (13) or one-half or one-third of the diameter or a maximum dimension of an impact region of the high-energy beam.

13. The device method according to claim 10, wherein
the analysis unit provides the analysis result of a control and/or regulating system for the control and/or regulation of the device.
